(19) United States
(12) Patent Application Publication
(10) Pub. No.: US 2026/0033498 A1
(43) Pub. Date: Feb. 5, 2026

(54) MECHANICAL DOUGH RISING MACHINE

(71) Applicant: RIDADA UNLU MAMÜLLER GIDA TICARET ANONIM SIRKETI, Sincan, Ankara (TR)

(72) Inventor: Davlet CHETYZ, Sincan, Ankara (TR)

(21) Appl. No.: 18/996,181

(22) PCT Filed: Jul. 20, 2023
(86) PCT No.: PCT/TR2023/050711

§ 371 Date: Jan. 17, 2025

(30) Foreign Application Priority Data
Jul. 20, 2022 (TR) 2022/011605

(51) Int. Cl. A21C 13/00; A21C 1/02

(52) U.S. Cl. CPC A21C 13/00; A21C 1/02

(57) ABSTRACT

Disclosed is a mechanical dough riser using a special mixing method under high pressure. The mechanical dough riser provides rise in a few minutes for the dough obtained from all kinds of flour types, low or gluten-free flours, all kinds of legumes and vegetable purees. It allows the dough embossing process to be carried out without the need for any chemical and riser support.

### TECHNICAL FIELD

The invention, without any swelling and fermentation process of the dough; It relates to a mechanical dough riser using a special mixing method under high pressure.

The mechanical dough riser allows to rise the dough obtained from all kinds of flour types, low or gluten-free flours, all kinds of legumes and vegetable purees in a few minutes. It allows the dough embossing process to be carried out without the need for any chemical and riser support.

### PRIOR ART

Nowaday, various chemicals and mechanical methods are used for dough embossing. In most of the systems used, carbon dioxide liquid is added to the dough together with pressure to provide relief. These developed systems are not suitable for mass production.

In the document with the application number CN215123725, which is related to the subject in the art, a bread fermentation, steaming and baking integrated machine is mentioned. In a single machine, three processes, namely bread fermentation, steaming and baking, are carried out. The mentioned machine has been developed to reduce the cost and number of machines in the enterprises. It is not mentioned that the dough is risen mechanically with high pressure and a special mixing method without any riser and fermentation process, and therefore it is different from our invention.

Kneading and whisking machine is mentioned in the document with the application number RU2010143952, which is another document related to the subject in the art. Said kneading and whisking machine kneading body includes a device for discharging the finished product. The bulk puffed dough is portioned after the process. In the aforementioned technique, it is different from our invention in that the dough embossing process is done in bulk before portioning.

In the document with the application number CN214431423, which is related to the subject in the art, the fermentation box placed inside the automatic dough leavening machine is mentioned. The mentioned automatic dough fermentation machine accelerates the dough fermentation process. It is not mentioned that the dough is risen mechanically with a special mixing method under high pressure without undergoing fermentation, and therefore it is different from our invention.

In the document with the application number RU2454865, which is related to the subject in the technique, the method of preparing unleavened dough is mentioned. The invention includes dosing the base and auxiliary raw materials into the airtight tank of the kneading container, kneading the raw materials in the carbon dioxide environment injected into the tank under pressure, and discharging the dough. It differs from our invention in that carbon dioxide is added to rise the dough.

In the document with the application number GEU20222114, which is related to the subject in the technique, dough rise is mentioned by adding mineral water (water/carbon dioxide solution) to the dough placed in the dough kneading machine. It differs from our invention in that it is raised by a leavening agent and fermentation process.

In the document with the application number RU2475028, which is related to the subject in the technique, the method of producing aerated dough bread, mixing and kneading the dough in intermediate molds, separating it into pieces of the specified weight and placing the dough in the oven molds after the baking process are mentioned. It is different from our invention because the working principle of the aeration mechanism used to transfer the dough from the intermediate containers to the baking dish after the aeration process and to rise the dough is different and it is not mentioned that the two synchronous forks rotate around themselves, while the platform on which the forks are attached makes a joint rotation movement.

In the document with the application number RU2755949, which is related to the subject in the art, processing equipment for cooking is mentioned. A kneading room with a lid and a kneading organ allow the preparation of unleavened dough to be divided into portions after the process. It differs from our invention in that the dough rise process is done in batches before portioning.

In the present applications, various methods are applied for the dough-free leavening process in the document referred to above. Generally, various leavening agents such as carbon dioxide liquid are added to the dough together with the pressure and the swelling process is provided. In the production process of the mentioned inventions, it is not suitable for mass production and automation, as it requires manual intervention in order to eliminate the deformities caused by the portioning of the baking dishes after the bulking process and the deflating problems of the dough.

### DESCRIPTION OF THE INVENTION

The mechanical dough riser realized to achieve the objectives of the present invention is shown in the attached figures.

From these shapes;

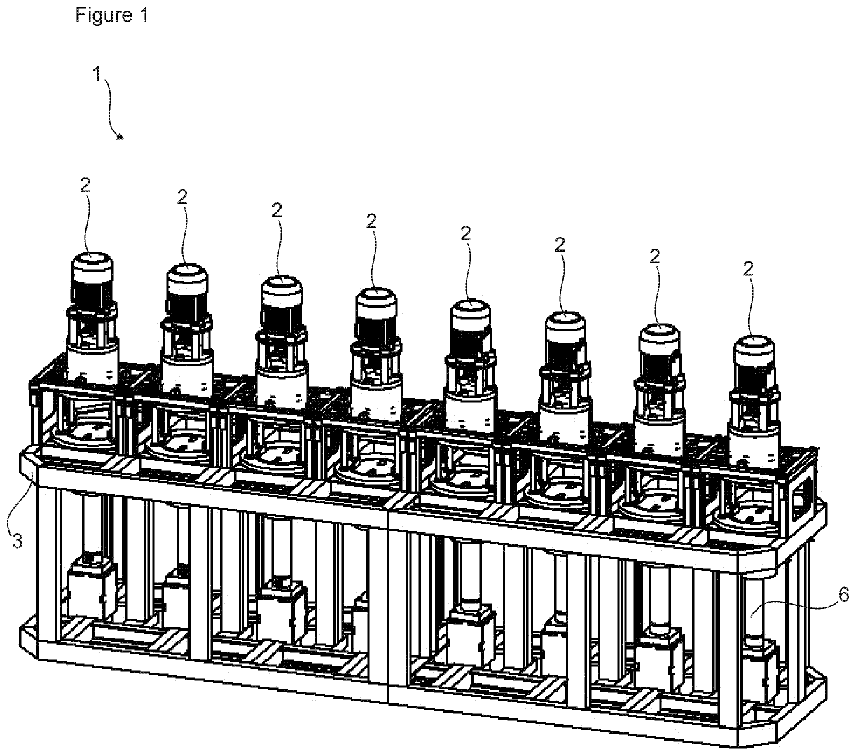

FIG. 1 is a front perspective view of the mechanical dough riser which is the subject of the invention.

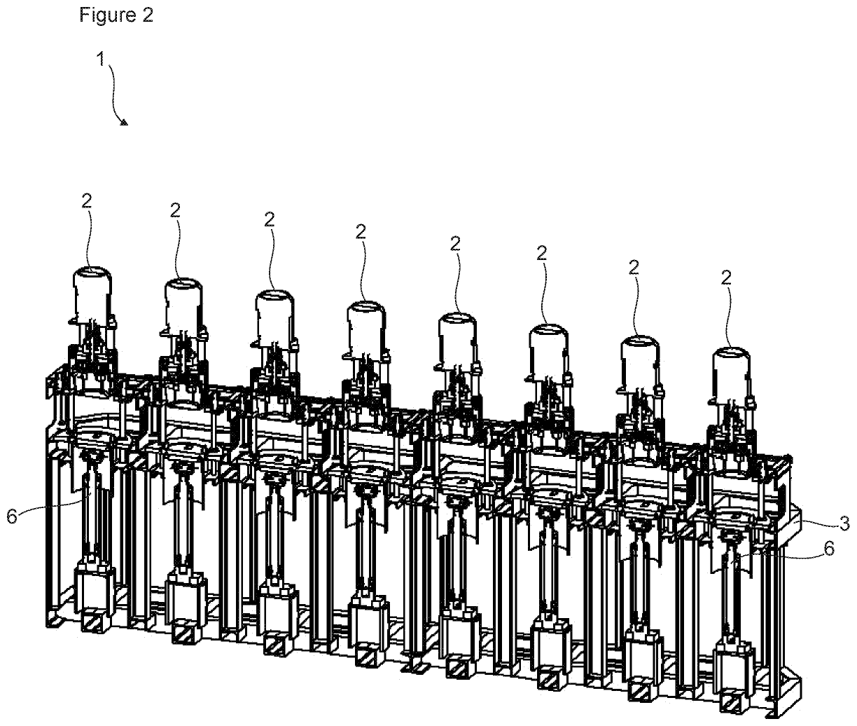

FIG. 2 is a perspective view of the section of the mechanical dough riser which is the subject of the invention.

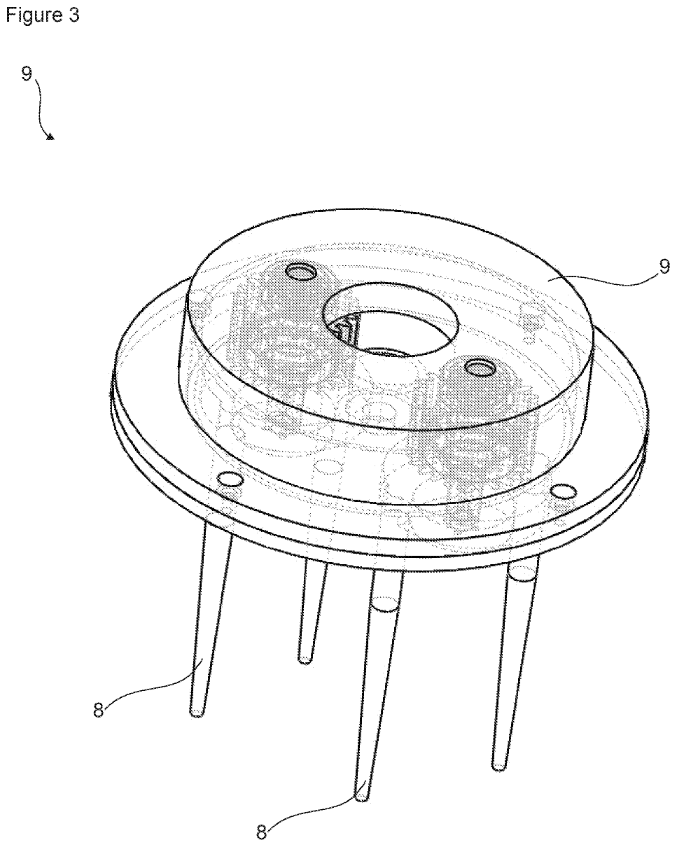

FIG. 3 is a perspective view of the rotating platform and the forks connected to the rotating platform of the mechanical dough riser, which is the subject of the invention.

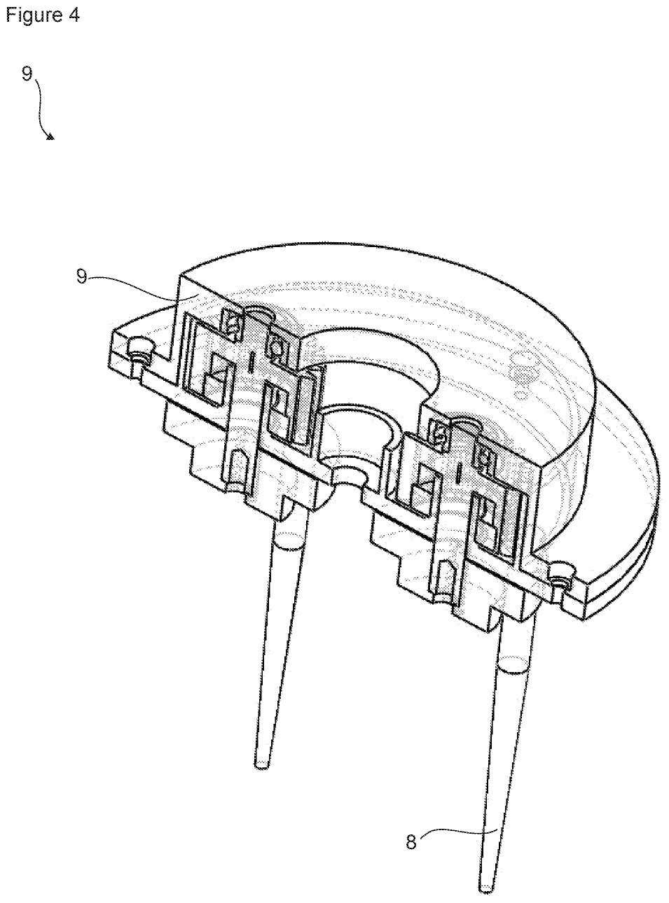

FIG. 4 is a perspective view of the cross-section of the rotating platform of the mechanical dough riser and the forks connected to the rotating platform, which is the subject of the invention.

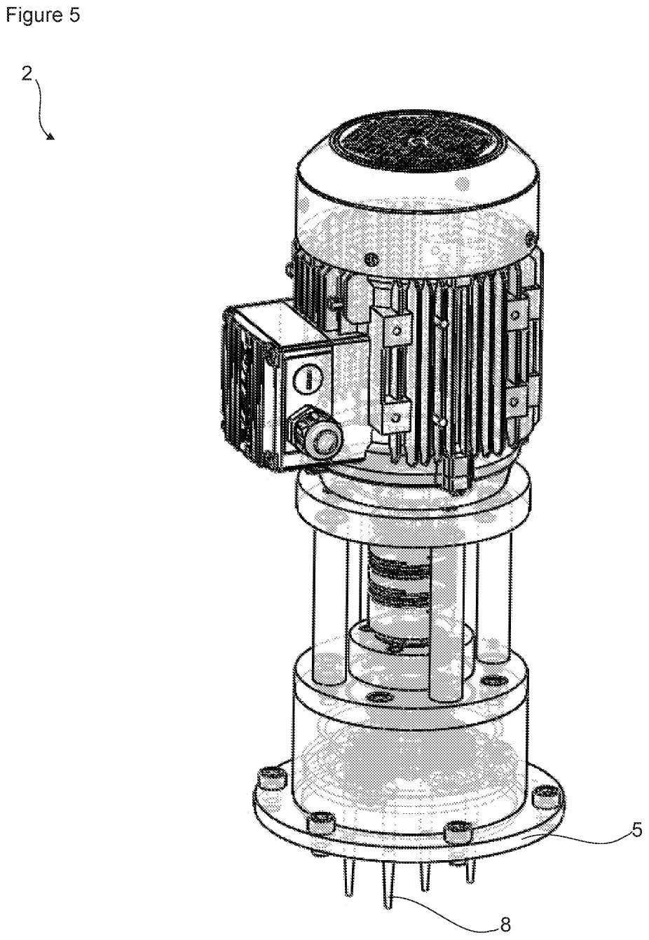

FIG. 5 is a perspective view of the dough airing unit belonging to the mechanical dough riser which is the subject of the invention.

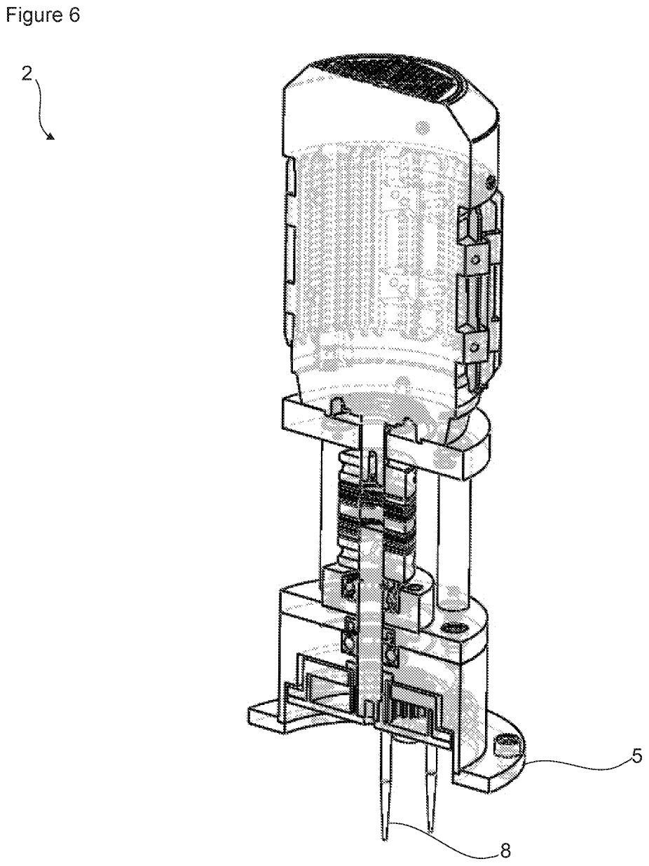

FIG. 6 is a perspective view of the cross section of the dough airing unit, which is the subject of the invention, belonging to the mechanical dough riser.

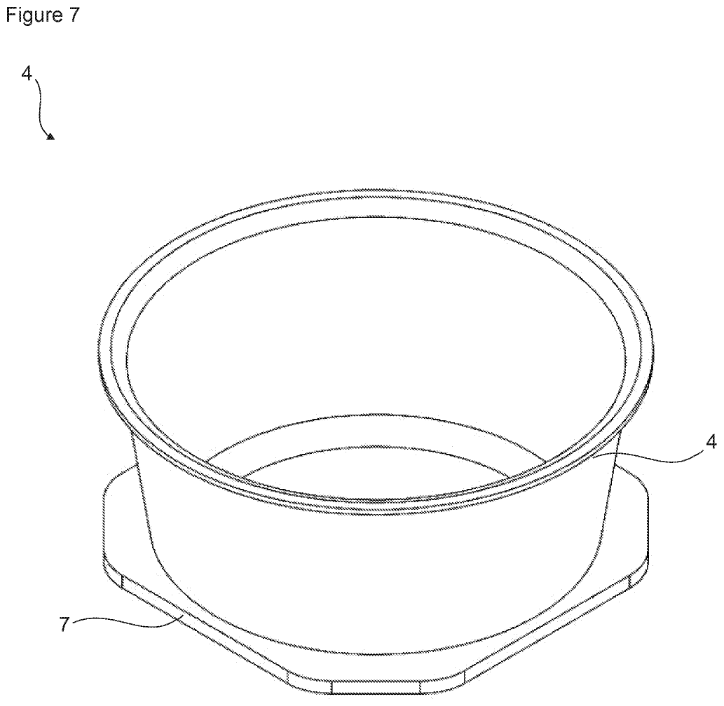

FIG. 7 is a perspective view of the dough container and fixing apparatus of the mechanical dough riser, which is the subject of the invention.

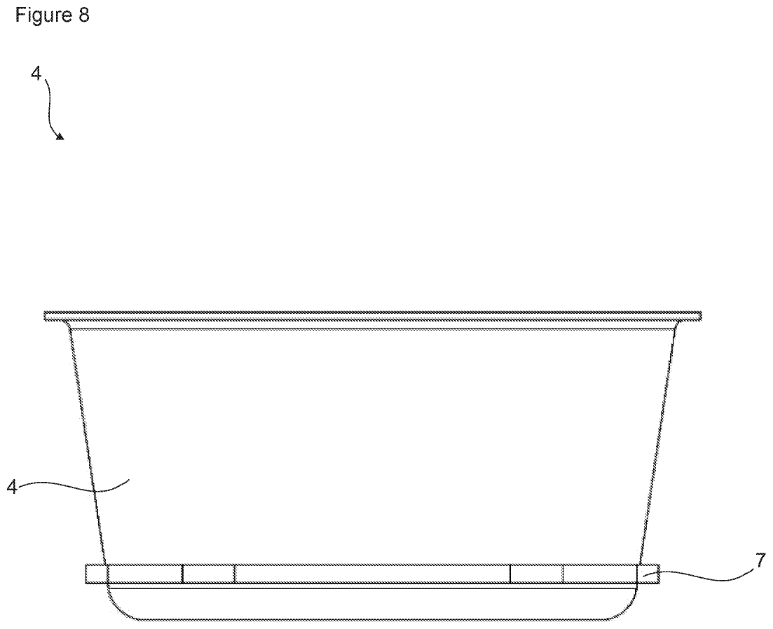

FIG. 8 The subject of the invention is a front view of the dough container and fixing apparatus of the mechanical dough riser.

The parts that make up the mechanical dough riser, which is the subject of the invention, are numbered as follows in the attached figures:
1—Mechanical Dough Riser
2—Dough Aeration Unit
3—Body
4—Dough Container
5—Sealed lid
6—Movable Platform
7—Fixing Apparatus
8—Fork
9—Rotating Platform

The subject of the invention is the mechanical dough riser (1) comprises the following;
Dough airing unit (2), which is the section where portion-based dough aeration is performed,
Body (3) consisting at least one dough aeration unit (2),
At least one dough container (4) with a geometric shape in the form of a circle, in which the portioned dough is placed,
A sealed lid (5), which ensures that the dough put into the dough container (4) maintains the pressure during the process and prevents the dough liquid from leaking out,
The movable platform (6), which allows the ventilation process to begin by combining with the sealed lid (5) when it moves upwards after the dough container (4) is placed on it,
Fixing apparatus (7), which has a rectangular or square geometric structure, which ensures the fixing of dough containers (4), which have a geometrical shape in the form of a circle, during the aeration process,
Two forks (8), which are positioned side by side during the aeration process and work synchronized with each other, taking the dough dragged by one of them in its rotation trajectory, and trapping air into the dough,
The rotating platform (9) on which the forks (8) are located, which provides aeration of the dough by making a synchronous rotation with the forks (8) with the power taken from the engine,

The dough aeration unit (2) and body (3) of the mechanical dough riser (1), which is the subject of the invention, provides the dough rising process without the need for any chemical and riser support.

The mechanical dough riser (1), which is the subject of the invention, can rise even more fluid doughs with a much higher liquid ratio compared to the machines currently used.

In the mechanical dough proving machine (1), which is the subject of the invention, the dough is baked in the oven with the same dough bowl (4), after the dough is made to rise with a single dough container (4) without using separate bowls. Thus, negative factors such as deformation and deflating caused by the dough being transferred from one container to another are eliminated.

Thanks to the geometric structure of the forks (8) and their synchronized movement with each other, the forks (8) reach all points of the dough container (4) and perform a homogeneous aeration process.

Since no chemical or yeast is used in the mechanical dough riser (1), which is the subject of the invention, it does not disturb the stomach, provides ease of digestion and eliminates indigestion.

Dough container (4); The dough prepared with flour (all types of flour or dried vegetables/legumes, puree, liquid), water and salt is portioned manually or by conveyors.

In the mechanical dough riser (1), which is the subject of the invention, the dough aeration process; Thanks to the aeration process per portion after portioning instead of portioning after it is made in bulk, negative effects such as losing the form and deflating of the dough after the process are prevented. Thus, the opportunity to rise twice as much dough is provided with the same amount of dough.

After the dough container (4) is placed on the movable platform (6), it is fixed with the fixing apparatus (7). Thus, during the dough airing process, the dough container (4), which is caused by the circular geometric shape of the dough bowl (4), rotates and the dough container (4), in which the dough is placed while the forks (8) and the rotating platform (9) are rotating, are prevented from decreasing the processing efficiency. Thanks to the angular geometric structure of the fixing apparatus (7), the dough It increases the efficiency of the ventilation process by fixing the dough container (4).

With the placement of the dough container (4), the movable platform (6) moves upwards and joins with the sealed lid (5) and the aeration process begins. The sealed lid (5) maintains the pressure of the dough placed in the dough container (4) during the process and prevents the dough liquid from leaking out.

The rotating platform (9), which starts its rotational movement with the power taken from the motor of the mechanical dough riser (1), which is the subject of the invention, transmits this movement to the forks (8), providing the rotation movement together. The rotation trajectory of the two forks (8), their position relations with each other, rotational speed and rotation are important. In the dough movement of two forks (8) working synchronously with each other, the dough dragged by one fork (8) is taken by the other fork (8) and air is trapped inside the dough, and this process is repeated for a period and cycle determined according to the dough type. Thus, the risen dough is much more durable and its initial volume can remain intact for up to an hour before baking.

In the mechanical dough riser (1), which is the subject of the invention, the settings of the dough aeration units (2) that perform the dough aeration process are made differently according to each dough type. For each dough type, the forks (8) and the rotating platform (9) work at different times and cycles to increase productivity.

The mechanical dough riser (1), which is the subject of the invention, provides the opportunity to aerate all types of flour (low gluten or gluten-free flours), all kinds of legumes and vegetable purees within a few minutes.

1. Mechanical dough riser comprising a clough aeration unit, which is the section where portion-based dough aeration is performed, a body comprising at least one dough aeration unit, at least one dough container with a geometric shape in the form of a circle, in which the portioned dough is placed, a sealed lid, which ensures that the dough put into the dough container maintains the pressure during the process and prevents the dough liquid from leaking out, a movable platform, which allows the ventilation process to begin by combining with the sealed lid when it moves upwards after the dough bowl is placed on it, a fixing apparatus, which has a rectangular or square geometric structure, which ensures the fixing of dough containers, which have a geometrical shape in the form of a circle, during the aeration process and wherein the mechanical dough riser comprises two forks, which are positioned side by side during the aeration process and work synchronized with each other, taking the dough dragged by one of them in its rotation trajectory, and trapping air into the dough and the rotating platform on which the forks are located, which provides aeration of the dough by making a synchronous rotation with the forks with the power taken from the engine.
